(19) United States
(12) Patent Application Publication
(10) Pub. No.: US 2008/0160059 A1
(43) Pub. Date: Jul. 3, 2008

(54) ANTIBIOTIC/ANTIMYCOTIC PREPARATION AND USE IN PLANTS

(75) Inventor: Miguel Enrique Alvarado Licon, Chihuahua (MX)

Correspondence Address: BELL, BOYD, & LLOYD LLP, P.O. BOX 1135, CHICAGO, IL, 60690, US

(73) Assignee: Quimica Agronomica de Mexico, Chihuahua (MX)

(21) Appl. No.: 11/936,406

(22) Filed: Nov. 7, 2007

(30) Foreign Application Priority Data
Nov. 8, 2006 (MX) PA/A/2006/012966

(51) Int. Cl. A01N 25/26; A01N 59/20; A01P 15/00

(52) U.S. Cl. 424/417; 424/632

(57) ABSTRACT

The present invention refers to a fungicide/bactericide formulation comprising oxytetracycline hydrochloride and copper oxychloride for use in plants.

### FIELD OF THE INVENTION

The present invention refers to a plant bactericidal-fungicidal formulation which comprises as active agents, oxytetracycline hydrochloride and copper oxychloride.

### BACKGROUND OF THE INVENTION

It is important to design an effective, cost effective and efficient formulation for the treatment, control and/or cure of bacterial diseases and fungal diseases in plants. The annual loss of plants and products thereof to bacterial and fungal disease is high. Therefore there is a need for a robust and cost effective treatment, which can be used in a wide variety of plants, which is easy to use.

### SUMMARY OF THE INVENTION

The bactericidal-fungicidal preparation of the present invention comprises in combination, oxytetracycline hydrochloride, or salt thereof, and copper oxychloride, as the active ingredients. The bactericidal-fungicidal preparation of the present invention is effective in controlling the growth of a wide range of microorganisms including species and genera, such as, Erwinia, Pseudomonas, Ralstonia, Xanthomonas, Agrobacterium and Corynebacterium, in general, gram⁻ species and gram⁺ species. Other organisms include Pseudomonas tabaci, P. angulata, P. lacrymans, P. phaseolitica, P. coronafaciens, P. pisi, P. delphinii, P. woodsii, P. marginalis, P. fluorescens, P. alliicola, P. cepacia, P. morosprunorum, P. gardeniae, P. solanaceaum, P. caryophylli, P. glycinea, P. syryngae, Ralstonia solanacearum, Xanthomonas phaseoli var. Sojensis, X. malvacearum, X. oryzae, X. translucens, X. oryzicola, X. pruni, X. vesicatoria, X. campestre, X. vasculorum, X. rubrilineans, X. citri, X. begoniae, X. gummisudans, X. pelargonii, X. juglandis, Corynebacterium insidiosumu, C. flacumufaciens, C. sepedomicum, C. michiganense, Erwinia trachephila, E. amylovora, E. carotovora var chrysanthemi, E. stewartii, E. carotovora var. atroseptica, Agrobacterium tumefaciens, A. rhizogenes, A. rubi, Burkholderia andropogonis, Acidovorax, such as A. avenae, Xylophilus, such as X. ampelinus, Xylella fastidiosa, Rhizomonas suberifaciens, Coryneforms, such as Clavibacter michiganensis, Streptomyces, such as, S. ipomoaea and S. acidiscabies, Bacillus, such as, B. thuringiensis, Clostridium, such as, C. cellulovorans and so on.

The bactericidal-fungicidal preparation of the invention also finds use in controlling a wide range of fungi including those of the genera, Alternaria, Botritys, Capnodium, Cerastomella, Cercospora, Colletotrichum, Corticium, Cladosporium, Coryneum, Curvularia, Diaporhe, Diplocarpon, Diplodia, Dothiorella, Elsinoe, Fabraea, Fusarium, Gloesporium, Glomerella, Anomia, Guignardia, Hemileia, Isiaropsis, Macrophomina, Monilia, Mycena, Mycosphaerella, Nectria, Omphalia, Peronospora, Pestalotia, Phodosphaera, Pyllachora, Phyllosticta, Phytophtora, Plasmopara, Pseudoperonospora, Puccinia, Septoria, Sphaceloma, Sphaeropsis, Sphaeroteca, Stemphylium, Taphrina, Tranzchelia, Uncinula, Uromyces, Venturia and so on.

The bactericidal-fungicidal preparation can be used in a wide variety of agriculturally beneficial species such as tobacco, vegetables, including cucumber, the Cruciferae, pea, corn, beans, such as soy beans, grains, including cotton, rice, alfalfa, oat and other cereals, members of Brassica, fruits, including apple, pear, peach, plum, tomato, banana, prune and citrus, tubers and bulbs, including potatoes and onions, nuts, including walnuts, grasses, including sugar cane and the like, as well as all species of the agavaceae family.

The bactericidal-fungicidal preparation also is beneficial in the treatment of nursery plants and ornamental plants, such as flowers, including chrysanthemum, begonia, gladiolus, geranium, carnations and gardenias.

The bactericidal-fungicidal preparation also finds use in the treatment of shade trees, forest trees, annual field crops and biannual field crops.

Other plant species in which the antibiotic/antimycotic preparation can be used are Espinas, Cotoneaster, Phyrachanthas, Stranvaesis, Fraxinus, Pyrus, Malus, Capasium, Cydonia, Crataegus and Soreus.

For example, the bactericidal-fungicidal preparation of the invention can be used on Amelanchier alnifolia, A. canadensis, A. laevia, Aronia arbutifolia, A. malanocarpa, Aruncus sylvester, Chaenomeles japonica, C. lagenaria, Cotoneaster acuminatus, C. adpressus Bois, C. affinis, C. ambiguus, C. apiculatus, C. ascendens, C. bullatus, C. bullatus f. floribunda, C. buxifolius, C. buxifolius f. vellaea, C. commixtus, C. congestus, C. conspicuous, C. dammeri, C. dielsianus C. divaricatus, C. elegans, C. floccosus, C. foveolatus, C. franchetti, C. frigidus, C. glabratus, C. glaucophyllus, C. harrysmithii, C. henryanus, C. hissarcus, C. horizontalis, C. ignavus, C. insignia, C. knasiensis, C. lacteus, C. laxiflorus, C. lucidus, C. melanocarpus, C. microphyllus, C. moupinensis, C. multiflorus, C. nanshan, C. nitens, C. obscurus, C. obtusus, C. pannosus, C. perpusillus, C. polyanthemus, C. prostrates, C. racemiflorus, C. roseus, C. rotundifolius, C. rubens, C. salcifolius, C. simonsii, C. soongoricus, C. spendens, C. sternianus, C. tenuipes, C. tomentosus, C. veitchii, C. villosulus, C. wardii, C. watereri, C. zabelii, Cowania stansburiana, Crataegomespilus dardarii, Crataegus arnoldiana, C. crusgalli, C. douglassi, C. flavellata, C. mollis, C. monogyna, C. oxyacantha, C. pedicellata, C. phaenopyrum, C. punctata, C. succulenta, C. uniflora, Cydonia oblonga, C. sinensis, Dichotomanthes tristaniaecarpa, Dryas sp., Eriobotrya japonica, Exochorda sp., Fragaria ananassa, F. virginiana, Geum sp., Heteromeles arbutifolia, Holodiscus discolor, Kageneckia oblonga, Kerria japonica, Malus malus spp., Mespilus germanica, Osteomeles anthyllidifolia, Peraphyllum ramossissimum, Photinia deflexa, P. glabra, Dioscoria villona, Physocarpus sp., Potentilla sp., Prinsepia sp., Prunus alleghaniensis, P. armeniaca, P. avium, P. besseyi, P. cerasifera, P. dasycarpa, P. domestica, P. fremontii, P. ilicifolia, P. lusitanica, P. mume, P. nigra, P. salicina, P. simonii, P. spinosa, P. triloba, Pyracantha angustifolia, P. atalantioides, P. coccinea, P. crenulata, P. crenulata var. Kansuensis, P. fortuneana, P. koidzummi, P. rogersiana, Raphiolepia indica, P. unbellata, Rhodotypos scandens, Rosa blanda, R. multifora, R. rubiginosa, R. rubrifolia, Rubus idaeus, Salycopersicum esculentum, Solanum tuberosum, Sorbaria sorbifolia, Sorbus americana, S. aria, S. aucuparia, S. mougeotii, S. occidentales, S. tianshanica, Spiraea cantoniensis, S. densiflora, S. vanhouteii and so on.

### DETAILED DESCRIPTION OF THE INVENTION

The present invention contains as active ingredients, oxytetracycline hydrochloride and copper oxychloride, each adhered to or by a suitable agriculturally acceptable particulate carrier, which in turn can be suspended in an agriculturally acceptable diluent, such as water or a fertilizer solution. The final concentrations can be about 1 to about 1500 μg/ml of oxytetracycline hydrochloride as well as about 1 to about 2000 μg/ml of copper oxychloride in the liquid. Other suitable amounts of oxytetracycline are about 0.5, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, about 1000, about 1100, about 1200, about 1300, about 1400 or about 1600 μg/ml of oxytetracycline HCI. Other suitable amounts of copper oxychloride are about 0.5, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, about 1000, about 1100, about 1200, about 1300, about 1400, about 1500, about 1600, about 1700, about 1800, about 1900 or about 2100 μg/ml of copper oxychloride.

For the purposes of the instant invention, the terms “bacteriostatic” and “bacteriocidal” can be used interchangeably, although the former generally means that bacterial growth is halted while the latter generally means that the bacteria are killed.

For the purposes of the instant invention, the terms “mycostatic” and “mycocidal” can be used interchangeably, although the former generally means that fungal growth is halted while the latter generally means that the fungi are killed.

The bactericidal-fungicidal preparation can be mixed as dry ingredients with a carrier or dry inert diluent, such as an agriculturally acceptable particulate which provides a fine, powdery formulation. The active ingredients can be obtained from commercial sources. Generally, a USP grade antibiotic is used. For example, oxytetracycline hydrochloride can be obtained from SINTOFARM S.P.A. and copper oxychloride can be obtained from Nacional Dermet, S.A. de C.V.

A suitable agriculturally acceptable particulate diluent is one that can serve as a carrier for the low concentrations of the two active agents, which adhere on and to the particulate. The dry diluent is one which readily suspends in suitable liquid diluents for administration to plants, such as water, without rapid dissolution so as to maintain the particulate structure while in the liquid diluent for application to the plant. The suspension assures even dispersion of an effective concentration of the bactericidal-fungicidal composition of interest on the plant. Generally such carriers are silica based, comprising any of a variety of silicates, alone or in combination, and can include other inert ingredients. Other agriculturally acceptable carriers can be used, so long as the active ingredients adhere to or are bound to the surface of those carriers.

While not wanting to be bound by theory, it is believed oxytetracycline HCl and copper oxychloride complex with the agriculturally acceptable particulate carrier.

Alternatively, the oxytetracycline and copper oxychloride can be mixed in a liquid diluent or carrier, such as water or a buffer, or an agriculturally acceptable liquid carrier or diluent. Such a formulation can be used as a dip for seeds, callus, seedlings or plantlings, or can be used as an injectable solution.

The instant invention rests on the observation that the combination of oxytetracycline and copper oxychloride provides for synergistic levels of antibacterial and/or antifungal activity against a wide variety of plant pathogens.

Regarding the dry bactericidal-fungicidal formulation, the appropriate weight of oxytetracycline hydrochloride, copper oxychloride, and the agriculturally acceptable carrier (inert), are weighed individually and placed into a dust mixer such as a “V-type” dust mixer made of rolled stainless steel. The formula components are fed through ports and the mixer is operated at a speed of about 15 revolutions per minute. On addition of the starting compounds, mixing is commenced for a period of about 10 minutes. The final finished formulation can be placed into suitable airtight and watertight bags, such as a polyethylene bag of suitable capacity, and stored in a dry state at room temperature, or that recommended by the manufacturers of the active ingredients.

In one embodiment, the dry formulation comprises about 0.1% to about 45% oxytetracycline. In another embodiment, the dry formulation comprises about 0.1% to about 75% copper oxychloride. A preferred concentration of oxytetracycline can be about 0.5%, about 1%, about 2%, about 3%, about 4%, about 5%, about 6%, about 7%, about 8%, about 9%, about 10%, about 15%, about 20%, about 25%, about 30%, about 35%, about 40% or about 50% oxytetracycline. A preferred concentration of copper oxychloride can be about 0.5%, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70% or about 80% copper oxychloride.

A suitable final concentration of active ingredients in the liquid diluent is on the order of 1-1500 μg/ml of oxytetracycline hydrochloride and 1-2000 μg/ml of copper oxychloride.

In one embodiment, the dry composition of interest is mixed or suspended in an agriculturally acceptable liquid carrier or diluent, such as water or a liquid fertilizer, at a rate of about 0.25 grams to about 2 grams of dry product per liter of liquid. The rate of dry to wet can be about 0.2 grams, about 0.3 grams, about 0.4 grams, about 0.5 grams, about 0.6 grams, about 0.7 grams, about 0.8 grams, about 0.9 grams, about 1 gram, about 1.1 grams, about 1.2 grams, about 1.3 grams, about 1.4 grams, about 1.5 grams, about 1.6 grams, about 1.7 grams, about 1.8 grams, about 1.9 grams or about 2.1 grams.

Then the diluted formulation is applied to the plants by any of the variety of art-recognized means. For example, the formulation can be applied to the plant surface by spraying. Alternatively, the solution can be introduced injectably into a plant, for example, with a syringe, when suspended or dissolved in a liquid carrier without being adhered to the agriculturally acceptable particulate carrier, or applied as a solid fertilizer-like preparation for absorption by the roots at the base of the plant, or a solution can be distributed at the base of the plant for absorption by the roots. The formulation can be applied as soon as the symptoms appear or prophylactically before the symptoms appear. The treatments can be repeated for another two-six times, or more, generally at an interval of about six-eight days between treatments, depending on the rainfall and climate. The application interval can be shortened appropriately in the event of rain.

Certain aspects of the invention will be described further in the following non-limiting examples. Unless otherwise indicated, amounts are in relation to (w/v) or (w/w).

### EXAMPLE 1

To determine the sensitivity of Burkholderia andropogonis, a stock was applied to commercially prepared agar-containing Petri dishes to provide dishes containing a lawn of bacteria. Then, absorbent discs containing a mixture of oxytetracycline hydrochloride and copper oxychloride, and each of the active ingredients separately, oxytetracycline hydrochloride alone and copper oxychloride alone were placed onto the bacterial lawn. The concentrations of the individual active agents in the discs were the same as that for each found in the combination. The combination and the individual actives were tested at three different concentrations. Each concentration was run in triplicate.

An analogous commercially available system for making routine determinations of bacterial and fungal sensitivity also was used.

When each of the active ingredients was tested separately, it was found that Burkholderia andropogonis was slightly more sensitive to oxytetracycline hydrochloride and than to copper oxychloride.

A synergistic effect was noted when oxytetracycline hydrochloride and copper oxychloride were combined and tested as to antimicrobial/antifungal effectiveness against Burkholderia andropogonis. The toxicity at each concentration was far greater than the sum of the toxicities of each active agent alone, for example, at the intermediate concentration tested, the bacteria kill zone for oxytetracycline was 3.3 mm in diameter; for copper oxychloride, the zone was 2 mm in diameter; but for the combination, the kill zone was 15 mm in diameter.

The bactericide/fungicide mixture also presented with a synergistic level of toxicity when analyzed on Rhizoctonia solani and Fusarium oxysporum.

### EXAMPLE 2

The present invention was tested in the field against carnation bacterial spot disease (Burkholderia andropogonis), as well as against carnation rust fungus disease (Uromyces caryophillinus).

### Study Location.

The trial was conducted in a commercial carnation farm in San Bartolo, Municipally of Villaguerrero, State of Mexico.

### Crop Used In the Study.

Carnation variety “Tibet”.

### Evaluation of the Bactericide/Fungicide Mixture-Technical Information.

The bactericide/fungicide mixture was formulated as a wettable powder. The active ingredients were oxytetracycline at 37.7%, equivalent to 350 g ai/Kg powder, and copper oxychloride at 45%, equivalent to 265.5 g ai/Kg of powder. The final product contained 17.3% of the inert solid particulate carrier. The mixture was biologically active on the phytopathogenic microbes studied, based on in vitro studies as described in Example 1.

Diseases Considered in this Study.

Carnation bacterial spot (Burkholderia andropogonis).

Carnation rust (Uromyces caryophyllinus).

### Experimental Design.

The experiment was established in a random block design with four repetitions. According to the planting system, the 9.6 m² experimental orchard was adequate with small protect crop tunnels with three furrows (0.8 m wide by 4.0 m length). The useful orchard was the central part of the experimental orchard.

### Treatments Evaluated.

TABLE 1
Treatments evaluated to control carnation bacterial spot and rust.

| | RATE |
|---|---|
| TREATMENTS | (PF (Gr)/200 L WATER) |
| 1. Oxytetracycline hydrochloride + copper | 100 |
| oxychloride (T1) | |
| 2. Oxytetracycline hydrochloride + copper | 150 |
| oxychloride (T2) | |
| 3. Oxytetracycline hydrochloride + copper | 200 |
| oxychloride (T3) | |
| 4. Control (T4) | |

PF: Formulated Product

STUDY CONFIGURATION

| | | | | |
|---|---|---|---|---|
| BI | T4 | T3 | T1 | T2 |
| BII | T1 | T2 | T4 | T3 |
| BIII | T3 | T4 | T2 | T1 |
| BIV | T2 | T1 | T3 | T4 |

### Treatment Application.

The treatment started when symptoms of disease were detected first. A 20 L Honda® motorized sprinkler was used with a calibrated cone mouthpiece to regulate the water volume/hectare. Four applications were performed every seven days.

### Evaluation of the Method.

A pre-evaluation of the plants was conducted the day of the experiment and before the first application of reagent. Subsequent evaluations were performed seven days after each application.

The leaves were checked for presence of disease. Samples were taken from the leaves under laboratory conditions to isolate the pathogen. Additionally, samples were obtained from the onset of the treatment regimen to identify the pathogen. Four applications at an interval of seven days were performed once the identification was confirmed.

The scales provided in Tables 2 and 3 were used as a guide to ascertain the stage of disease, and thus, to measure the effect of the product in treating the disease. Generally, leaves and vascular tissue were examined. Five random plants were examined per experimental plot. Twenty leaves were examined per experimental plot.

TABLE 2
Scale to evaluate symptoms caused by carnation bacterial
spot (Burkhloderia andropogonis).

| Scale | Description |
|---|---|
| 0 | Healthy plant |
| 1 | Leaves had intervenal lesions of less than 1 cm with |
| | grey-green color |
| 2 | Lesions larger than 1 cm with purple coloration |
| 3 | Lesions from 2 to 3 cm in size with slightly purple cracks, |
| | no damage to stems |
| 4 | Coalescence of lesions, red to purple cracks with damage |
| | in the stems |
| 5 | Vascular tissue affected, lesions in leaves and stems |

TABLE 3
Scale to evaluate rust damage (Uromyces caryophillinus) in carnation.

| Scale | Description |
|---|---|
| 0 | Healthy plant |
| 1 | Small chlorotic areas |
| 2 | Pustule presence in leaves with erumpent tissue |
| 3 | Up to 6.25% of the foliage area contains pustules |
| 4 | Up to 12.5% of leaves damaged |
| 5 | Up to 25% of leaves damaged |
| 6 | Up to 50% of leaves damaged |
| 7 | More than 50% of leaves damaged |

Crop phytotoxicity was evaluated with the EWRS proposed scale as provided in Table 4.

TABLE 4
EWRS score to evaluate fungicide/bactericide
phototoxic effect in carnation.

| Score | Description |
|---|---|
| 1 | Absolute absence of symptoms-healthy plant |
| 2 | Slight symptoms, some atrophy |
| 3 | Slight symptoms but clearly appreciable |
| 4 | Stronger symptoms, without negative effect in the harvest |
| 5 | Strong chlorosis or atrophy, affect on the harvest |
| 6 | Increasing damage up through crop disappearance |

### Data Analysis Method.

Scores for each evaluation were transformed to percentage of infection by the Townsend-Heuberger formula. Those percentages were subjected to analysis of variance and compared in the Tukey test and/or the Duncan test to determine significance. All of the analyses were conduced using a statistical package software obtained from the Universidad Autonoma de Nuevo Leon, other software for performing such statistical analyses and treatments are commercially available and can be used. Differences were considered when significant at least at the 5% confidence level. Furthermore, treatment efficacy as compared to control was calculated with Abbott's formula.

### Treatment Efficacy.

$$\% Ef = \frac{Cd - Td}{Cd} \times 100$$

where:
Ef=biological efficacy
Cd=infestation in control land plot after treatment
Td=infestation in experimental land plot after treatment

### Analysis and Results.

Pretest sampling of the infection rate of B. andropogonis in carnation.

Symptoms of disease were just beginning to be observable on the carnation leaves, injuries of green-grayish color were vaguely observable on the leaves of some plants.

TABLE 5
Mean percentage of B. andropogonis infection prior to
treatment in carnation crop.

| | | Expected | |
|---|---|---|---|
| | | Rate (g | |
| | | PF/200 L | % infection by |
| Treatment | Product | water) | B. andropogonis |
| 1 | Oxytetracycline | 100 | 6.00 |
| | chlorhydrate + copper | | |
| | oxychloride | | |
| 2 | oxytetracycline | 150 | 9.00 |
| | chlorihydrate + copper | | |
| | oxychloride | | |
| 3 | oxytetracycline | 200 | 6.00 |
| | chlorhydrate + copper | | |
| | oxychloride | | |
| 4 | Untreated control | — | 8.00 |

PF: Formulated Product.

First evaluation of carnation infection percentage by B. andropogonis.

At the first evaluation, the percentage of damage by B. andropogonis in the carnation crop increased in the untreated control nearly doubling from 8% to 14%. Purple spots were evident.

On the other hand, in the bactericidal-fungicidal treatment plots, the infection percentage by carnation bacterial spot was significantly reduced, see Table 6.

TABLE 6
Mean percentage of Burkholderia andropogonis infection
following the first treatment.

| | Rate (g | | Tukey | % |
|---|---|---|---|---|
| | PF/200 L | % Infection by | significance | efficacy |
| Product | water) | B. andropogonis | at 95% | (Abbott) |
| oxytetracycline | 100 | 4.00 | B | 71.42 |
| chlorhydrate + | | | | |
| copper | | | | |
| oxychloride | | | | |
| oxytetracycline | 150 | 4.00 | B | 71.42 |
| chlorhydrate + | | | | |
| copper | | | | |
| oxychloride | | | | |
| oxytetracycline | 200 | 3.00 | B | 78.57 |
| chlorhydrate + | | | | |
| copper | | | | |
| oxychloride | | | | |
| untreated | — | 14.00 | A | — |
| control | | | | |

PF: Formulated Product.
A, B statistically significant difference.

Second evaluation of infection rate of carnation by B. andropogonis.

The untreated control at the second evaluation time point following the second treatment, at 7 DDCA (days after application), showed continued development of bacterial spot among the plants, see Table 7. On the other hand, treatment with the fungicide/bactericide mixture maintained a low incidence rate of no more than 4%. The efficacy of treatment for all three concentrations of the product of interest were greater than 80%.

TABLE 7
Mean percentage of Burkholderia andropogonis infection
following the second treatment.

| | Rate (g | | Tukey | |
|---|---|---|---|---|
| | PF/200 L | % of infection by | significance | % efficacy |
| Product | water) | B. andropogonis | at 95% | (Abbott) |
| oxytetracycline | 100 | 4.00 | B | 81.81 |
| chlorhydrate + | | | | |
| copper | | | | |
| oxychloride | | | | |
| oxytetracycline | 150 | 3.00 | B | 86.36 |
| chlorhydrate + | | | | |
| copper | | | | |
| oxychloride | | | | |
| oxytetracycline | 200 | 3.00 | B | 86.36 |
| chlorhydrate + | | | | |
| copper | | | | |
| oxychloride | | | | |
| untreated | — | 22.00 | A | — |
| control | | | | |

PF: Formulated Product.
A, B statistically significant difference.

Third evaluation of infection rate of carnation by B. andropogonis.

Seven days after the third application (third evaluation), while the disease progressed in the untreated plots, the treatment effect with the mixture kept the infection rate at 5% or lower, with an efficacy of 93% at the highest concentration of product. Moreover, in the treated groups, the symptoms of bacterial spot were minimal, and did not go beyond a low level of intervenal injury with grayish color.

TABLE 8
Mean percentage of Burkholderia andropogonis infection
following the third treatment.

| | Rate (g | | Tukey | |
|---|---|---|---|---|
| | PF/200 L | % of infection | significance | % efficacy |
| Product | water) | B. andropogonis | at 95% | (Abbott) |
| oxytetracycline | 100 | 5.00 | B | 82.75 |
| chlorhydrate + | | | | |
| copper | | | | |
| oxychloride | | | | |
| oxytetracycline | 150 | 3.00 | BC | 89.65 |
| chlorhydrate + | | | | |
| copper | | | | |
| oxychloride | | | | |
| oxytetracycline | 200 | 2.00 | C | 93.10 |
| chlorhydrate + | | | | |
| copper | | | | |
| oxychloride | | | | |
| untreated | — | 29.00 | A | — |
| control | | | | |

PF: Formulated Product.
A, B, C statistically significant difference.
BC No difference.

Fourth evaluation of infection rate in carnation by B. andropogonis.

In this stage of the study, the disease continued to progress, and the treatments provided a statistically significant improvement over control. Treatment efficacy was about 95% at the two higher concentrations (Table 9).

TABLE 9
Mean percentage of Burkholderia andropogonis infection
following the fourth treatment.

| | Rate (g | | Tukey | % |
|---|---|---|---|---|
| | PF/200 L | % of infection by | significance | efficacy |
| Product | water) | B. andropogonis | at 95% | (Abbott) |
| oxytetracycline | 100 | 5.00 | B | 85.29 |
| chlorhydrate + | | | | |
| copper | | | | |
| oxychloride | | | | |
| oxytetracycline | 150 | 2.00 | C | 94.17 |
| chlorhydrate + | | | | |
| copper | | | | |
| oxychloride | | | | |
| oxytetracycline | 200 | 1.00 | C | 97.05 |
| chlorhydrate + | | | | |
| copper | | | | |
| oxychloride | | | | |
| untreated | — | 34.00 | A | — |
| control | | | | |

PF: Formulated Product.
A, B, C statistically significant difference.

Table 10 shows a mean comparison of the infection rate caused by carnation rust (U. caryophyllinus) prior to treatment. Small chlorotic spots appeared on some carnation leaves.

TABLE 10
Mean percentage of Uromyces caryophyllinus infection
prior to treatment in carnation crop.

| | Expected Rate | |
|---|---|---|
| | (g PF/200 L | % infection by |
| Product | water) | U. caryophyllinus |
| oxytetracycline | 100 | 7.10 |
| chlorhydrate + copper | | |
| oxychloride | | |
| oxytetracycline | 150 | 4.22 |
| chlorhydrate + copper | | |
| oxychloride | | |
| oxytetracycline | 200 | 5.67 |
| chlorhydrate + copper | | |
| oxychloride | | |
| untreated control | — | 5.67 |

PF: Formulated Product.

First evaluation at 7 DDCA (days after each application).

The disease progressed in the untreated plots. Treatment with the product of interest essentially halved the infection rate, see Table 11. Some of the plants in the untreated control showed foliage with light pustules and erumpent tissue.

TABLE 11
Mean percentage of Uromyces caryophyllinus infection
following the first treatment.

| | Rate (g | | Tukey | % |
|---|---|---|---|---|
| | PF/200 L | % of infection by | significance | efficacy |
| Product | water) | U. caryophyllinus | at 95% | (Abbott) |
| oxytetracycline | 100 | 4.97 | B | 53.33 |
| chlorhydrate + | | | | |
| copper | | | | |
| oxychloride | | | | |
| oxytetracycline | 150 | 4.25 | C | 60.09 |
| chlorhydrate + | | | | |
| copper | | | | |
| oxychloride | | | | |
| oxytetracycline | 200 | 4.25 | C | 60.09 |
| chlorhydrate + | | | | |
| copper | | | | |
| oxychloride | | | | |
| untreated | — | 10.65 | A | — |
| control | | | | |

PF: Formulated Product.
A, B, C statistically significant difference.

Second Evaluation.

The statistically significant differences between the treatment groups and the untreated control plots were maintained at the 95% confidence level, see Table 12.

TABLE 12
Mean percentage of Uromyces caryophyllinus infection
following the second treatment.

| | Rate (g | | Tukey | % |
|---|---|---|---|---|
| | PF/200 L | % infection by | significance | efficacy |
| Product | water) | U. caryophyllinus | at 95% | (Abbott) |
| oxytetracycline | 100 | 4.97 | BC | 58.82 |
| chlorhydrate + | | | | |
| copper | | | | |
| oxychloride | | | | |
| oxytetracycline | 150 | 4.25 | BC | 64.78 |
| chlorhydrate + | | | | |
| copper | | | | |
| oxychloride | | | | |
| oxytetracycline | 200 | 2.82 | C | 76.63 |
| chlorhydrate + | | | | |
| copper | | | | |
| oxychloride | | | | |
| untreated | — | 12.07 | A | — |
| control | | | | |

PF: Formulated Product.
A, C statistically significant difference.
BC No difference.

### Third Evaluation.

The presence of pustules on leaves with erumpent tissue was more evident in some plants in the untreated control group, see Table 13. On the other hand, plants in the treatment plots showed just a few chlorotic spots.

TABLE 13
Mean percentage of Uromyces caryophyllinus infection
following the third treatment.

| | Rate (g | | Tukey | |
|---|---|---|---|---|
| | PF/200 L | % infection by | significance | % efficacy |
| Product | water) | U. caryophyllinus | at 95% | (Abbott) |
| oxytetracycline | 100 | 5.67 | C | 69.46 |
| chlorhydrate + | | | | |
| copper | | | | |
| oxychloride | | | | |
| oxytetracycline | 150 | 4.97 | C | 73.23 |
| chlorhydrate + | | | | |
| copper | | | | |
| oxychloride | | | | |
| oxytetracycline | 200 | 4.27 | C | 77.00 |
| chlorhydrate + | | | | |
| copper | | | | |
| oxychloride | | | | |
| untreated | — | 18.57 | A | — |
| control | | | | |

PF: Formulated Product.
A, C statistically significant difference.

Fourth Evaluation.

At 7 DDCA (days after application) after the fourth treatment, the statistically significant differences between the treatment plots and the untreated plots were maintained, see Table 14.

TABLE 14
Mean percentage of Uromyces caryophyllinus infection
following the fourth treatment.

| | Rate (g | | Tukey | |
|---|---|---|---|---|
| | PF/200 L | % infection by | significance | % efficacy |
| Product | water) | U. caryophyllinus | at 95% | (Abbott) |
| oxytetracycline | 100 | 5.70 | C | 75.05 |
| chlorhydrate + | | | | |
| copper | | | | |
| oxychloride | | | | |
| oxytetracycline | 150 | 4.97 | C | 78.24 |
| chlorhydrate + | | | | |
| copper | | | | |
| oxychloride | | | | |
| oxytetracycline | 200 | 4.28 | C | 81.26 |
| chlorhydrate + | | | | |
| copper | | | | |
| oxychloride | | | | |
| untreated | — | 22.85 | A | — |
| control | | | | |

PF: Formulated Product.
A, C statistically significant difference.

### CONCLUSIONS

The fungicide/bactericide mixture of oxytetracycline hydrochloride and copper oxychloride, administered at rates of 100, 150 and 200 g of formulated product per 200 liters of water, provided good treatment and control of carnation bacterial spot and carnation rust. No adverse effects attributed to the treatment composition were detected.

While the invention has been described with reference to specific examples and reference herein, the skilled artisan will recognize that various changes and modifications readily can be made to the teachings herein without departing from the spirit and scope of the instant invention.

I claim:

1. A composition for plants comprising a bacteriostatic or bacteriocidal amount of oxytetracycline hydrochloride, a mycostatic or mycocidal amount of copper oxychloride, and, optionally, an agriculturally acceptable inert particulate carrier, wherein said oxytetracycline and said copper oxychloride adheres to said particulate carrier surface.

2. The composition of claim 1, wherein said particulate carrier comprises a silicate.

3. The composition of claim 1, wherein the amount of said oxytetracycline hydrochloride is about 0.1% to about 45% (w/w).

4. The composition of claim 1, wherein the amount of said copper oxychloride is about 0.1% to about 75% (w/w).

5. The composition of claims 1 to 4, wherein said composition is mixed with an agriculturally acceptable liquid diluent.

6. The composition of claim 5, wherein said composition comprises from about 0.25 grams to about 2.0 grams per liter of said liquid diluent.

7. The composition of claim 5, wherein said liquid diluent comprises water.

8. A method of treating plants comprising exposing plants suspected of being infected with a pathogenic microorganism to the composition of claim 1.

9. The method of claim 8, wherein said composition comprises said particulate carrier, and said exposing comprises suspending said composition in an agriculturally acceptable liquid.

10. The method of claim 9, wherein said exposing comprises applying said liquid to a plant surface.

11. The method of claim 9, wherein said exposing comprises applying said liquid to the base of a plant.

12. The method of claim 8, wherein said exposing comprises applying said composition of said oxytetracycline and said copper oxychloride to the base of a plant.

13. The method of claim 8, wherein said exposing comprises introducing said composition of said oxytetracycline and said copper oxychloride into a plant.

14. The method of claim 9, wherein the concentration of copper oxychloride is from about 1 to about 2000 μg/ml.

15. The method of claim 9, wherein the concentration of oxytetracycline hydrochloride is from about 1 to about 1500 μg/ml.
